(19) United States
(12) Patent Application Publication
(10) Pub. No.: US 2015/0301321 A1
(43) Pub. Date: Oct. 22, 2015

(54) Modified Schmidt-Cassegrain Telescope For Use In A Free-Space Optical Communications System

(71) Applicant: AOptix Technologies, Inc., Campbell, CA (US)

(72) Inventors: J. Elon Graves, Los Gatos, CA (US); Malcolm J. Northcott, Felton, CA (US); Seigfried Fleischer, Campbell, CA (US); Rebecca Chang, Campbell, CA (US); Paolo Zambon, Campbell, CA (US)

(73) Assignee: AOptix Technologies, Inc., Campbell, CA (US)

(21) Appl. No.: 13/799,923

(22) Filed: Mar. 13, 2013

Related U.S. Application Data
(60) Provisional application No. 61/771,353, filed on Mar. 1, 2013.

(51) Int. Cl. G02B 17/08; H04B 10/40; H04B 10/11

(52) U.S. Cl. CPC G02B 17/0888; H04B 10/11; H04B 10/40

(57) ABSTRACT

A Cassegrain telescope uses a pivoted corrector plate to reduce back-reflections. A converging lens is added to the optical path inside a housing of the telescope to focus the light within the telescope. The modified Cassegrain design may be used a hybrid radio frequency and free-space optical commercial communications network.

### CROSS REFERENCE TO RELATED APPLICATIONS

This application claims the benefit of U.S. Provisional Application No. 61/771,353, filed Mar. 1, 2013, which is incorporated by reference in its entirety.

### BACKGROUND

Embodiments of the disclosure relate generally to commercial communication networks. Specifically, embodiments of the disclosure relate to a modified Schmidt-Cassegrain telescope, for example for use in a free-space optical communications network.

With recent advances in technology, there is an increasing interest in the use of free-space optical communications for various applications. For example, much of the current telecommunications infrastructure is based on the transmission of optical signals via optical fibers. While the use of fiber optics has increased the capacity and efficiency of data transmission, there are many situations where the installation of new fiber is not the best solution. As a result, there is interest in augmenting the telecommunications infrastructure by transmitting optical signals through the free space of the atmosphere.

Free-space optical communications links can also be used advantageously in applications outside of the telecommunications infrastructure. Compared to other communications technologies, a free-space optical communications link can have advantages of higher mobility and compact size, better directionality (e.g., harder to intercept), faster set up and tear down, and/or suitability for situations where one or both transceivers are moving. Thus, free-space optical communications links can be used in many different scenarios, including in airborne, sea-based, space and/or terrestrial situations.

### SUMMARY

Embodiments described below include apparatus and methods for a modified Schmidt-Cassegrain telescope design. Examples include adapting a commercial off-the-shelf (COTS), low cost telescope for use in a hybrid radio frequency and free-space optical commercial communications network. Example adaptations of the COTS telescope are based on modifying a Schmidt-Cassegrain telescope, for example by adding a positive lens to the optical path inside a housing of the telescope, and pivoting the corrector plate to reduce back-reflections from being transmitted as an optical signal originating at a transceiver of the communications system.

Using the additional positive lens causes a received optical signal to converge to a focal point inside the telescope housing and, more importantly, before reaching an optical sensor. One benefit of this is greater receiver/transmitter immunity to background illumination because it allows for tight spatial filtering of the telescope field of view. Another benefit is a more compact physical design because the focal point is inside the telescope body (i.e., between the primary and secondary mirrors). Tilting the corrector plate results in a benefit of reducing unwanted back-reflections. Furthermore, these benefits are achieved using a readily available, low cost, COTS telescope for an otherwise specific application that would typically require a more customized and expensive optical component.

Additional embodiments include customized designs based on the principles described above. Further aspects include applications, systems, methods, component and devices relating to all of the above, for example transceivers and/or communications systems and networks using such telescopes.

### BRIEF DESCRIPTION OF THE DRAWINGS

FIG. 1 is a high level illustration of a telescope used in a context of an optical communications network, in an embodiment.

FIG. 2 is an illustration of an optical communications transceiver system that comprises a transceiver telescope and systems for communicating a signal between the transceiver telescope and other components of the communications system, in an embodiment.

FIG. 3 is an example of a modified commercially available telescope adapted for use in a free-space optical commercial communications network, in an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Structure

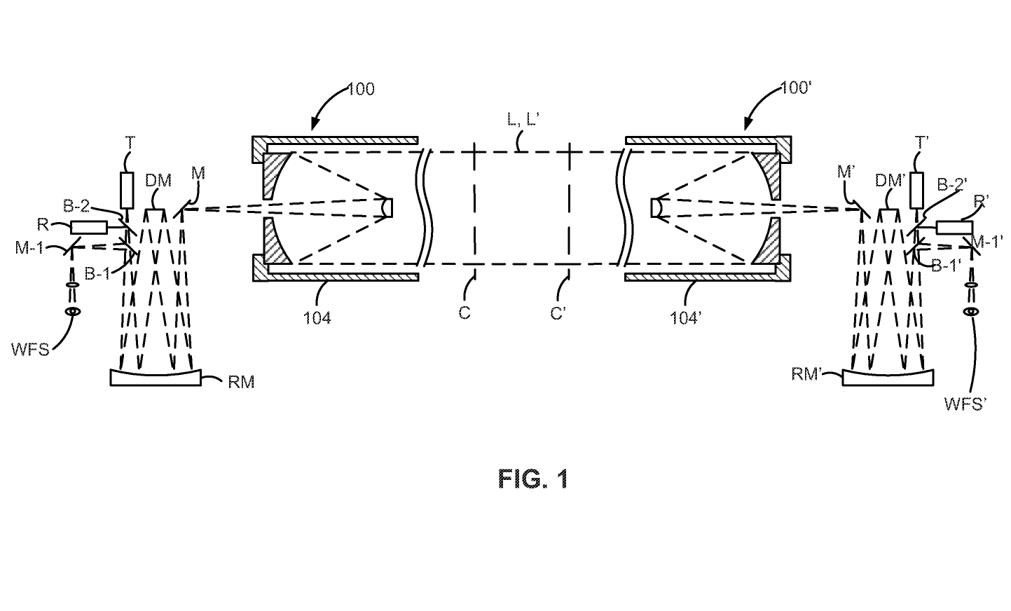

FIG. 1 shows one embodiment of a free-space optical data communication system, in which an adaptive optics system is provided on each of the transceivers 100 and 100′. This embodiment provides context for discussing a telescope 104, 104′ in a free-space optical data communications system and discussing the benefits of specific telescope designs as described below.

Each adaptive optics transceiver 100, 100′ includes a wavefront sensor WFS, WFS′ and a deformable mirror DM, DM′ for sensing and compensating for aberrations in the light waves L′, L, transmitted by the associated telescope 104′, 104, respectively. The light waves L, L′ sensed by the respective wavefront sensors may be the same light waves that are encoded with the data being transmitted, or the light waves can be separate light waves. For convenience of description, it will be assumed that the light waves that are being received and sensed by the respective wavefront sensors are the same as the data-encoded light waves.

Each transceiver 100, 100′ is provided with a light wave transmitter T, T′ of any convenient type, such as, a fiber optic light wave source, for transmitting data-encoded light into the associated telescope 104, 104′. Each transceiver 100, 100′ is also provided with a receiver R, R′ for receiving the data-encoded light from the associated telescope in a bi-directional transmission arrangement. For clarity and simplicity, the data transmission in only one direction will be described (i.e., from transceiver 100′ to transceiver 100), but it will be understood that data-encoded light is also being transmitted simultaneously in the opposite direction. In the case of bidirectional transmission, each telescope acts as both a transmitter and a receiver.

In this embodiment the light L′ first is transmitted through beamsplitters B-2′ and B-1′ to a relay mirror RM′ where the light is conjugated to a deformable mirror DM′, back to relay mirror RM′, and then to mirror M′. Mirror M′ then directs the light L′ to telescope 104′ that transmits the light to telescope 104. The light waves L′ received by telescope 104 of transceiver 100 are transferred to a mirror M from which the light waves are directed to a relay mirror RM. The relay mirror RM may be a parabolic mirror. Examples of mirrors M, M′, deformable mirrors DM, DM′ and relay mirrors RM, RM′ are described in U.S. Pat. Nos. 7,102,114; 7,406,263; 6,721,510; 6,464,364; 6,874,897; all of which are incorporated by reference in their entirety. Furthermore, embodiments of the deformable mirror DM can be as simple as a tip-tilt corrector or more complicated to correct for multiple atmospheric aberration modes.

Continuing, the incoming light waves are then directed to, and reflected from, the deformable mirror DM back to the relay mirror RM from which the light waves are directed to two beamsplitters B-1 and B-2. These beamsplitters B-1 and B-2 are positioned in series to reflect a portion of the light and transmit therethrough the remaining portion of the light reaching that beamsplitter in a conventional manner. The light waves reflected by the first beamsplitter B-1 are directed to the wavefront sensor either directly or indirectly from another mirror M-1. The initial transmission of light waves L′ from transceiver 100′ that reach the wavefront sensor normally will have aberrations caused by the atmospheric conditions between the transceivers 100 and 100′. These aberrations will be sensed and identified by the wavefront sensor, as disclosed more fully in the aforementioned U.S. Pat. No. 6,452,145.

In turn, the wavefront sensor will via a feedback loop control the shape of the deformable mirror DM to compensate for the aberrations in the wavefront of the light waves L′, whereupon the wavefront sensor will then sense a compensated wavefront as corrected by the deformable mirror DM with the aberrations eliminated or virtually so. Thus, the portion of the light waves L′ passing through the beamsplitter B-1 are also corrected and a portion thereof will be reflected by the beamsplitter B-2 to a light wave receiver R of the transceiver 100 as the data-encoded light in virtually the same form that was transmitted by the transmitter T′ of the transceiver 100′.

As the atmospheric conditions along a line-of-sight between the two transceivers 100 and 100′ change, they create new or different aberrations in the light waves L′. This change in condition will be sensed by the wavefront sensor for modifying the deformation of the deformable mirror DM to compensate for the changed aberrations whereby the light receiver R continually receives corrected light waves as a result of the operation of the adaptive optics system comprising the wavefront sensor and the deformable mirror DM.

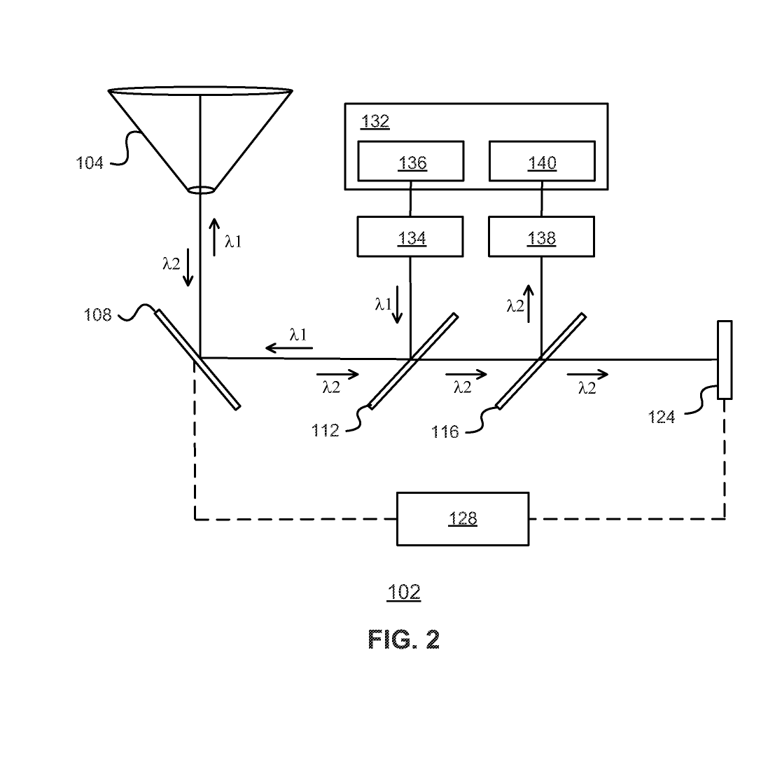

FIG. 2 is an illustration of the transceiver system 102, which is in communication with, for example, the transceiver 100. The transceiver system 102 can be used with a hybrid radio frequency and a free-space optical commercial communications network. In this illustration, the optically active components of the system 102 include a modified, commercial off-the-shelf (COTS) telescope 104 (also shown in FIG. 1), a fast steering mirror 108 (or other types of wavefront correction device), a dichroic mirror 112, a beamsplitter 116, and a wavefront sensor 124. The system 102 also includes elements used to control the system and manipulate data signals. The control elements include controller 128 (or other type of feedback loop). The data paths includes a processor 132 having a first data port 136 and a second data port 140. They also include a light source 134 (i.e., light transmitter) and sensor 138 (i.e., light receiver).

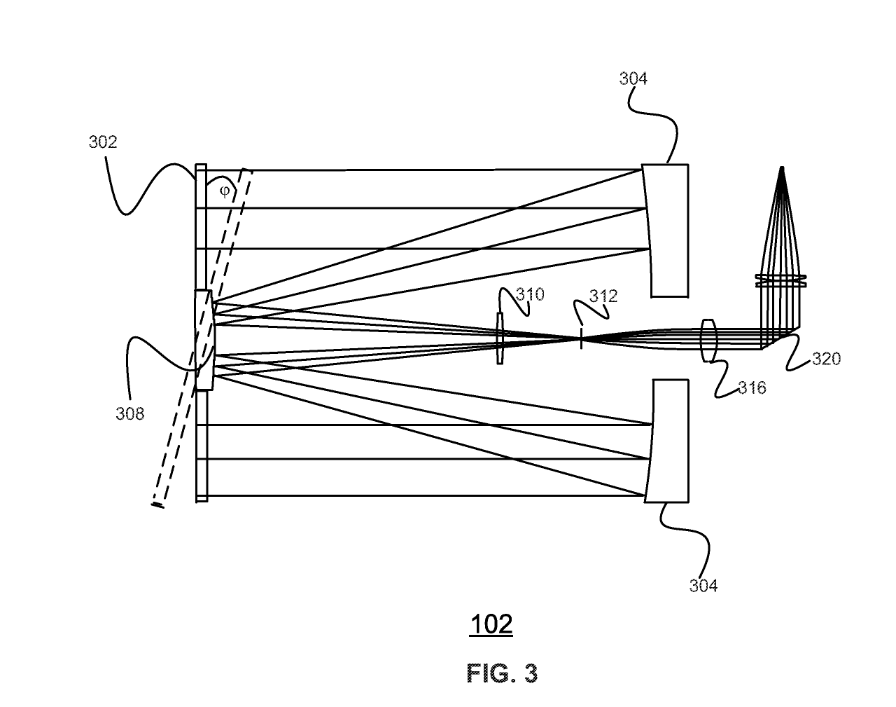

In this example, the COTS telescope 104 is a commercial Schmidt-Cassegrain telescope that has been modified to function as a transceiver of a communications network. The modifications made to the telescope 104 are described in FIG. 3. Consistent with its use as a transceiver, the telescope 104 transmits signals on a transmitting wavelength λ1 and receives signals on a receiving wavelength λ2. In some examples, these wavelengths are centered about a wavelength of 1500 nm, which is safe for human eyes.

The fast steering mirror 108 corrects the wavefront of a signal received by the system 102. The received signal is transmitted through the optical path of the system 102 to the wavefront sensor 124, which senses the wavefront of the received signal. This is transmitted to the controller 128, which calculated a desired correction and communicates a control signal to the fast steering mirror 108 to correct the incoming signal. The fast steering mirror 108 changes its orientation according to the control signals to improve the quality of the signal as it is transmitted through the optical path.

The dichroic mirror 112 and beamsplitter 116 are used to direct optical signals along the correct optical paths. In the receive direction, light (having wavelength λ2) encoded with data is passed by the dichroic mirror 112 and then a portion is split to the sensor 138. The sensor 138 detects the received light, which is then processed in electrical form by processor 132. The remaining light from beamsplitter 116 is passed to the wavefront sensor 124, where it is used in a feedback loop for mirror 108, as described above. In the transmit direction, light (having wavelength λ1) is produced and encoded with data by light source 134. The dichroic mirror 112 directs the light to the steering mirror 108 and then to the telescope for transmission to the other transceiver.

FIG. 3 is an embodiment of the telescope 104 that can be used as an optical transceiver in the system 102. This example telescope 104 is a modified version of a COTS Schmidt-Cassegrain telescope. The unmodified telescope includes a spherical concave primary mirror 304, a convex secondary mirror 308 positioned downstream of the primary mirror, and a corrector plate 302 positioned upstream of the primary mirror. For convenience, the terms upstream and downstream are defined relative to the light path through the telescope. The modified telescope also includes a collimating relay 316 and a reflector 320. This example telescope 104 also includes an additional element, a positive (converging) lens 310. This positive lens 310 is used to focus a received optical signal within the telescope at focal point 312.

Light enters the telescope 104 through a corrector plate 302, which is an aspheric optical element, for example used to correct spherical aberration introduced by other optical components. Having this function, corrector plate 302 is designed to introduce spherical aberration into the transmitted light that is approximately equal to, but opposite of, the aberration introduced by the primary mirror. In one embodiment, a COTS corrector plate is thicker in the middle and at the edges, which then focuses reflected light having a spherical aberration introduced by the primary mirror into focus at approximately a single focal point, thereby correcting the aberration. The COTS corrector plate typically is rotationally symmetric, with a useful aperture that is annular in shape. It typically is positioned around the outside of the secondary mirror 112.

Unlike in a COTS telescope, corrector plate 302 in the modified telescope is tilted at an angle φ relative to the optical axis, as shown by the dashed outline. This can be achieved by pivoting the corrector plate 302 about an approximate center point (e.g., a point approximately in the center of the corrector plate). The tilt directs undesirable back-reflections outside the field of view. The benefit of this configuration is that these reflections are not unintentionally transmitted back towards the transmitter. This configuration (and its corresponding benefit) typically are not used in COTS telescopes, which are typically used to receive (and not transmit) optical signals. This tilting is not applied to most other optically active components of the telescope 104 because these other components are usually strongly curved, and therefore naturally reflect back-reflections out of the optical path. Because the corrector plate 302 is one of the few optical components having a relatively flat surface, it is tilted to reflect back-reflections out of the optical path. Another benefit of tilting the corrector plate 302 is that the back-reflections are removed using the components of a COTS telescope, unlike other methods of removing back-reflections that may use a parabolic primary mirror, diamond-turned mirrors, or other custom optical components, which avoids the need for a corrector plate.

In this example, the corrector plate 302 is tiled an angle φ that is approximately half of the radial field of view of the telescope 104. If the full field of view of the telescope is 2φ, the corrector plate 302 will reflect back-reflections out of the optical path (i.e., outside an angle of 2φ) when tilted at least an angle of φ. Put in another way, the field of view of the telescope defines an object field. Any object within the object field will be detected by the telescope. By tilting the corrector plate 302 by this amount, any ray originating from within the object field will be reflected by the corrector plate to outside the object field. For example, if an embodiment of the telescope 104 has a full field of view of 5°, the corrector plate 302 would be tilted at an angle φ of least 2.5°. Other angles of φ can be used depending on the configuration of the telescope 104.

The primary mirror 304 and secondary mirror 308 are the main imaging elements within the telescope. The two mirrors are positioned along an optical axis of the telescope, facing each other. The primary mirror 304 has a central aperture. The two mirrors 304 and 308 work in concert to produce a focal point that, in the COTS telescope, lies beyond the central aperture.

This configuration is altered in embodiments of the present disclosure. A positive lens 310 is added downstream of the secondary mirror 308. The positive lens 310 is used to focus received optical signals reflected from the secondary mirror 308 to a focal point 312 that is within the telescope 104 (i.e., before the central aperture of the primary mirror 304). This is unlike a COTS telescope, which typically has a focal point outside of the telescope where it is more convenient to place the sensor.

In one example, the additional positive lens 310 is used to reduce the length of the telescope 104 by focusing the received signal within the telescope at interior focal point 312. By bringing the focal point 312 within the telescope, an already compact COTS Schmidt-Cassegrain telescope can be shortened even further. This can in turn, reduce production costs, and enable installation of the telescope 104 is areas that are more physically restrictive. The benefit of this is that locations that are difficult to access or are confined can still host a transceiver of the communications system.

In other examples, a collimating relay 316 collimates the light from focal point 312. A reflector 320 turns the optical path and additional optical elements then refocus the light. The overall effect is to relay light from focal point 312 to a secondary focal point located outside the central aperture. Transceiver components (e.g., sensor, light source, wavefront sensor) can then be positioned at the secondary focal point.

In other embodiments of the system 102, various optical components can be coated with anti-reflective coatings. For example, anti-reflective coatings can be applied to one or more optical surfaces, especially to the surfaces of refractive optics such as the corrector plate 302 or positive lens 310. In other examples, wavelength-selective coatings can also be used. For example, the front surface of the corrector plate 302 can be coated to reject ambient light. For example, if the transceiver operates in the 1300 nm or 1500 nm wavelength ranges, then a coating can be used to pass the wavelengths of interest but reject other wavelengths, including visible light.

### Closing

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure. For example, the telescope designs described above can be fabricated as original equipment, rather than modifying a COTS telescope.

In addition, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A modified Schmidt-Cassegrain telescope comprising:
a spherical concave primary mirror with a central aperture and a convex secondary mirror located downstream of the primary mirror, wherein the primary mirror and secondary mirror are positioned along an optical axis of the telescope facing each other and create a focal point that is beyond the central aperture; and
a corrector plate positioned upstream of the primary mirror, wherein the corrector plate is tilted relative to the optical axis by at least half of a field of view of the telescope.

2. The modified Schmidt-Cassegrain telescope of claim 1, wherein the corrector plate is tilted by at least 2.5° relative to the optical axis.

3. The modified Schmidt-Cassegrain telescope of claim 1, wherein the corrector plate is positioned annularly around the secondary mirror.

4. The modified Schmidt-Cassegrain telescope of claim 1, wherein the corrector plate corrects for spherical aberration.

5. The modified Schmidt-Cassegrain telescope of claim 1, wherein the corrector plate is rotationally symmetric.

6. The modified Schmidt-Cassegrain telescope of claim 1, wherein the corrector plate is not rotationally symmetric due to the tilt.

7. The modified Schmidt-Cassegrain telescope of claim 1, wherein light rays that originate from within an object or source field as defined by the field of view are reflected by the corrector plate to outside the object field.

10. The modified Schmidt-Cassegrain telescope of claim 1, wherein the corrector plate includes an anti-reflective coating.

11. The modified Schmidt-Cassegrain telescope of claim 1, further comprising:
a positive lens positioned on the optical axis downstream of the secondary mirror, the positive lens repositioning the focal point from beyond the central aperture to before the central aperture.

12. The modified Schmidt-Cassegrain telescope of claim 11, wherein the positive lens is coated with an anti-reflective coating.

13. The modified Schmidt-Cassegrain telescope of claim 11, wherein all refractive optics located between the entrance aperture and the central aperture includes at least one anti-reflective coating.

14. The modified Schmidt-Cassegrain telescope of claim 11, wherein at least one optical component comprises a wavelength-selective coating that rejects ambient light.

15. A commercial off-the-shelf Schmidt-Cassegrain telescope having a corrector plate, a concave primary mirror and a secondary mirror; the commercial off-the-shelf Schmidt-Cassegrain telescope modified by tilting the corrector plate relative to the optical axis by at least half of a field of view of the telescope.

16. The telescope of claim 15, wherein the commercial off-the-shelf Schmidt-Cassegrain telescope is further modified by adding a positive lens positioned on an optical axis downstream of the secondary mirror, the positive lens repositioning a focal point of the telescope to a location between the primary mirror and the secondary mirror.

17. A transceiver for use in a free-space optical communications system, the transceiver comprising:
a modified Schmidt-Cassegrain telescope, comprising:
a spherical concave primary mirror with a central aperture and a convex secondary mirror located downstream of the primary mirror, wherein the primary mirror and secondary mirror are positioned along an optical axis of the telescope facing each other and create a focal point that is beyond the central aperture; and
a corrector plate positioned upstream of the primary mirror, wherein the corrector plate is tilted relative to the optical axis by at least half of a field of view of the telescope; and
an optical relay path that relays light from the repositioned focal point to a secondary focal point located outside the central aperture;
a wavefront correction device positioned in the optical relay path for correcting a wavefront of the relayed light; and
a wavefront sensor and feedback loop to the wavefront correction device, for sensing the wavefront of the relayed light and communicating a control signal to the wavefront correction device based on the sensed wavefront.

18. The transceiver of claim 17, further comprising:
a positive lens positioned on the optical axis downstream of the secondary mirror, the positive lens repositioning the focal point from beyond the central aperture to before the central aperture;

19. The transceiver of claim 17, wherein the wavefront correction device is a deformable mirror.

20. The transceiver of claim 17, wherein the wavefront correction device is a steering mirror.

21. The transceiver of claim 17, further comprising:
a sensor positioned at the secondary focal point for detecting light received by the modified Schmidt-Cassegrain telescope from a remote location, the received light encoded with data.

22. The transceiver of claim 21, further comprising:
a light source positioned to transmit light encoded with data through the modified Schmidt-Cassegrain telescope to a remote location.
